(19) United States
(12) Patent Application Publication
(10) Pub. No.: US 2009/0037782 A1
(43) Pub. Date: Feb. 5, 2009

(54) Detection of address decoder faults

(75) Inventor: Paul Stanley Hughes, Sunnyvale, CA (US)

Correspondence Address: NIXON & VANDERHYE, PC, 901 NORTH GLEBE ROAD, 11TH FLOOR, ARLINGTON, VA, 22203, US

(73) Assignee: ARM LIMITED, Cambridge (GB)

(21) Appl. No.: 11/882,455

(22) Filed: Aug. 1, 2007

(51) Int. Cl. G06F 11/00

(52) U.S. Cl. 714/53; 714/E11.001

(57) ABSTRACT

A memory 2 is formed having an array of memory cells 4 arranged in rows 14. An address decoder 6 generates a word line signal WL in response to an input address to select one of the rows of memory cells for access. The word line signal also accesses address identifying data associated with the row of memory cells being accessed. This address identifying data is compared with the input address by fault detection circuitry 10. If a mismatch is detected, then this indicates a fault within the address decoder 6.

### BACKGROUND OF THE INVENTION

1. Field of the Invention

This invention relates to the field of data processing systems. More particularly, this invention concerns the detection of faults within address decoders used when accessing arrays of memory cells.

2. Description of the Prior Art

It is known to provide memories comprising one or more arrays of memory cells each with an address decoder serving to decode an input address so as to generate a word line signal for accessing a row of memory cells within the array. As process geometries scale to smaller sizes and operating voltages lower there is an increase in the likelihood of the occurrence of soft errors and/or hard errors within such memories, e.g. a strike from a charged particle inducing a disruption which changes the value of a bit being stored within a memory or a gate failing thereby corrupting the data value concerned. Some memory devices can be used in critical environments where the integrity of the data is very important. In order to help reduce the problems associated with data corruption, it is known to provide error correcting codes (ECCs) stored within the memory in association with the data. Such error correcting codes allow for the detection of an error in a stored bit value and the correction of that bit value. Depending upon the particular error correcting code scheme employed, it may be possible to correct bit errors using an associated error correcting code, but the amount of storage required for the ECC codes increases with the maximum number of bit errors they are able to correct. Such ECC memory consumes more circuit area due to the need to store the error correcting codes in addition to the data of interest. This additional overhead is disadvantageous in terms of cost, power consumption and efficiency, but is justified when the integrity of the data is important and a degree of fault tolerance is necessary, e.g. in a safety critical system, such as a car anti-lock break system.

Another more subtle problem which can arise with memories concerns the correct operation of the address decoder. Soft or hard errors can arise in an address decoder such that an input address signal is decoded, but serves to generate a word line signal to the incorrect row of memory cells with the data from that incorrect row of memory cells then being returned as if it had come from the correct row of memory cells. The data itself will match its error correcting code values and thus will not be detected as erroneous. Within a safety critical system, such an error in address decoder operation could have severe consequences. One proposal for dealing with such errors within the address decoder is to split the data and the error correcting codes into different portions of the memory, each with their own address decoder such that an input address is separately decoded by the different address decoders to access the data values and the error correcting codes for those data values. Thus, if an error occurs in either of the address decoders, then the error correcting codes will not match the data values and it may be possible to detect an error.

Whilst this is a superficially attractive proposal, it suffers from significant real life disadvantages. The area overhead associated with having to provide a second address decoder is significant and disadvantageous. Furthermore, error correcting codes are primarily intended for the detection and correction of one or two single bit errors within a data value covered by that error correcting code. In the case of address decoder malfunction, the data values are likely to be completely different to those intended to be covered by the error correcting code thus overwhelming any capacity of the error correcting code to correct those errors, and in some circumstances producing a false result in which the error correcting code by chance happens to match completely different data recovered as a consequence of the address decoder fault. For example, a single error correct double error detect (SEC-DED) code may fail to detect address decoder errors in up to 25% of cases. This level of potential error may be unacceptable in certain applications.

### SUMMARY OF THE INVENTION

Viewed from one aspect the present invention provides a memory comprising:

an array of memory cells;

an address decoder responsive to an input address to generate a word line signal to enable access to a row of memory cells within said array, said word line signal also enabling a read of address identifying data associated with said row and indicative of an address of said row; and

a decoder fault detecting circuit responsive to said input address and said address identifying data to detect incorrect address decoder operation if said address identifying data of said row accessed with said word line signal does not match said input address.

The invention recognises that a word line signal generated by an address decoder to access a row of data values within a memory array can also be used to access data values indicative of the address of that row of memory cells. Thus, the data returned will include both the data values themselves and data indicative of the address of those data values. The data indicative of the address of those data values can then be compared within the input address which was supplied to the address decoder and any mismatch therebetween can be used to detect an error in the address decoder. Since the addresses associated with the rows of memory cells are static, the data identifying the addresses can be stored in a relatively efficient manner reducing the overhead associated with its storage.

Whilst it would be possible for different rows of memory cells to share common data identifying address values so as to reduce the number of bits which need to be provided in the data identifying the address values, such an arrangement would mean that in a small number of cases an address decoder fault could by coincidence access an incorrect row of memory cells that happens to have the correct address identifying data. Such a possibility can be avoided if each of the rows of memory cells has a different address identifying data associated therewith.

The address identifying data could take a variety of different forms, such as being the result of a hashing function performed upon the input address. Another possibility is to form the address identifying data from one or more of those bits of the input address which vary for the different rows of the memory array. High order bits which are common to all rows of the memory array need not be used and similarly low order bits which correspond to different positions within a row of memory cells need not be used. If unique address identifying data for each row of memory cells is desired, then this may be formed from all of the bits which vary within the input address for the different rows of memory cells.

The address identifying data can be stored in a variety of different ways. It could be stored physically separately from the memory cells storing the data values providing that the same word line signal is used to at least trigger access both the data values and the address identifying data. However, in practice it will be likely to be more efficient and convenient to store the address identifying data in close association with the row of memory cells concerned in the form of either further programmable memory cells or read only memory cells.

Read only memory cells can be smaller and more efficient than programmable memory cells reducing the overhead associated with the current technique, but suffer from the disadvantage of requiring a higher degree of custom design and being less well adapted for automated generation with existing memory compiler tools. When programmable memory cells are used to store the address identifying data, it is desirable that these should be programmed with address identifying data in a manner which does not use the address decoder for which fault protection is being provided. If the protected address decoder is used, then it is possible that erroneous operation thereof may result in the incorrect address identifying data being programmed into a row of memory cells and incorrect operation not being properly identified. In some embodiments, the address identifying data can be programmed by a separate programming circuit acting independently of the address decoder and/or by a process which operates upon initialisation of the memory either before or after a test has been performed (i.e. associated with the test) to confirm the correct operation of the address decoder, such as a BIST (built in self test) operation performed at system boot.

As previously mentioned memories can be provided with error correcting codes serving to detect errors within the data values stored therein and provide a facility for correcting small numbers of such errors. Such techniques can synergistically be used in combination with the present technique of storing address identifying data for the rows of memory cells. Thus, the error correcting codes provide protection for the data values stored and the address identifying data provides protection to ensure the correct data is accessed in response to an input address. These techniques used in combination provide a highly fault resistant and robust memory system.

It will be appreciated that the memory to which the present technique is applied can take a wide variety of different forms. As examples, it may be part of a cache memory or a random access memory as well as other different forms of memory. The memory may be a compiled memory, in which the extra memory cells to store the address identifying data are provided by adjusting the compilation parameters for that memory.

The memory may be provided on a discrete integrated circuit, but is likely to be formed as part of a system-on-chip integrated circuit in combination with other circuit elements.

Viewed from another aspect the present invention provides a memory comprising:

an array of memory cells;

address decoder means for generating a word line signal in response to an input address to enable access to a row of memory cells within said array, said word line signal also enabling a read of address identifying data associated with said row and indicative of an address of said row; and

decoder fault detecting means for detecting incorrect address decoder operation in response to said input address and said address identifying data if said address identifying data of said row accessed with said word line signal does not match said input address.

Viewed from a further aspect the present invention provides a method of operating a memory having an array of memory cells, said method comprising the steps of:

decoding an input address to generate a word line signal to enable access to a row of memory cells within said array, said word line signal also enabling a read of address identifying data associated with said row and indicative of an address of said row; and

detecting incorrect decoding if said address identifying data of said row accessed with said word line signal does not match said input address.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a memory incorporating a mechanism for detecting faults in an address decoder;

FIG. 2 schematically illustrates operation of the memory of FIG. 1 when no fault is present in the address decoder;

FIG. 3 schematically illustrates the operation of the memory of FIG. 1 when a fault is present in the address decoder;

FIG. 4 is a table illustrating the variation in detection rate and area with the number of bits allocated to store the address identifying data within a 64-bit wide RAM with 1024 rows;

FIG. 5 compares various address decoder fault detection schemes for an 8 kB 64-bit wide memory;

FIG. 6 illustrates a second example embodiment of a memory having a mechanism for detecting errors in an address decoder;

FIG. 7 illustrates a memory address and those bits within the memory address which select the row within a memory array;

FIG. 8 is a flow diagram schematically illustrating the operation of the memory of FIG. 6; and

FIG. 9 is a diagram schematically illustrating a system-on-chip integrated circuit memory incorporating several memories which may use the address decoder fault detection technique described above.

### DESCRIPTION OF THE PREFERRED EMBODIMENTS

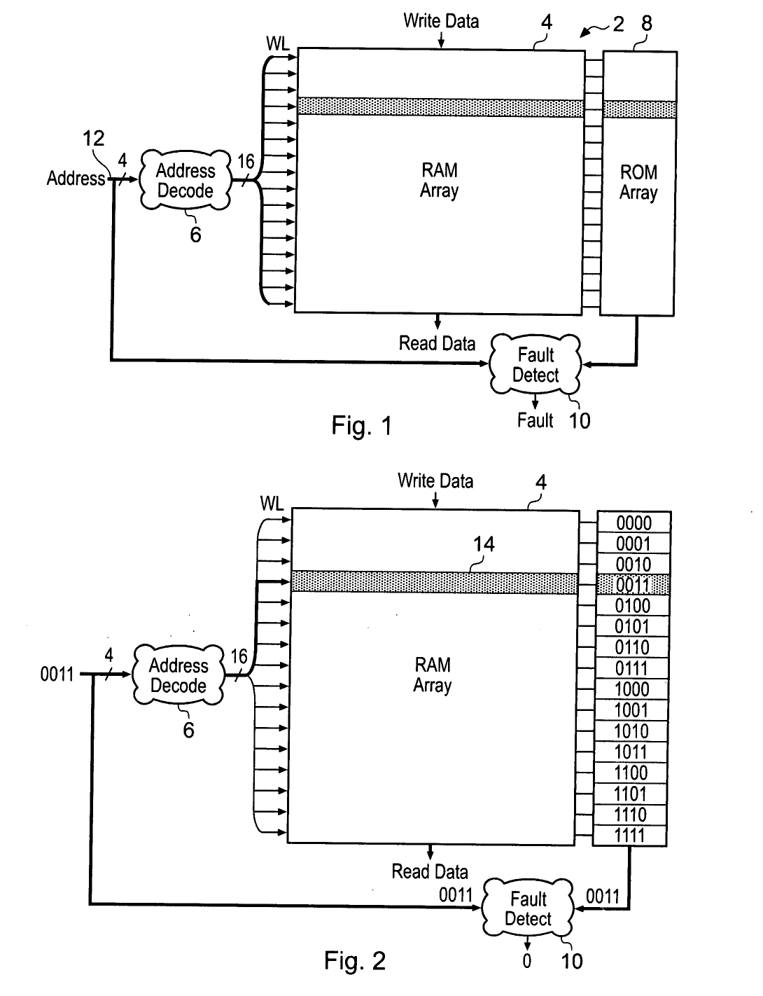

FIG. 1 illustrates a memory 2 comprising an array 4 of memory cells (not illustrated, but can have one of the standard forms of a RAM memory cell), an address decoder 6, a ROM array 8 storing address identifying data and a fault detecting circuitry 10. In operation, an input address is supplied upon address bus 12 and is decoded by the address decoder 6. In this example, the address is a 4-bit address allowing one of 16 different rows of memory cells within the array 4 to be selected by a corresponding word line signal WL. When the addressed row of memory cells is selected, then the data values therein can either be read or written in the standard way depending upon the particular operation being performed.

Associated with each row of memory cells within the array 4 are 4-bits of address identifying data stored within the ROM array 8. There is one group of 4-bits of address identifying data for each row of memory cells within the array 4. The individual address identifying data entries can be, for example, a simple 4-bit number ranging between 0 and 15 labelling the different respective rows of memory cells within the array 4. When a word line signal WL is generated by the address decoder 16, then it is used to provide access to one of the rows of memory cells within the array 4 and is also passed to the ROM array 8 where it triggers a read operation of the address identifying data (label) for that memory row with that address identifying data being passed to the fault detecting circuitry 10. Within the fault detecting circuitry 10 the address identifying data read from the ROM array 8 for the row of memory cells which is being accessed by the word line signal WL which has been generated is compared with the 4-bit address upon the address bus 12. If these match, then the correct row of memory cells has been accessed. If these do not match, then the incorrect row of memory cells has been accessed and there is a fault within the address decoder 6.

FIG. 2 illustrates the operation of the memory of FIG. 1 reading the fourth row of memory cells 14 within the array 4. This row of memory cells 14 corresponds to the address (0011) and in this example the address decoder 6 correctly generates the appropriate word line signal WL and causes the memory row 14 with the address identifying bits (label) stored within the ROM array 8 as “0011” to be read therefrom. The input address “0011” is compared with the read address identifying data “0011” by the fault detecting circuitry 10 and a match is detected indicating that the correct row of memory cells has been accessed.

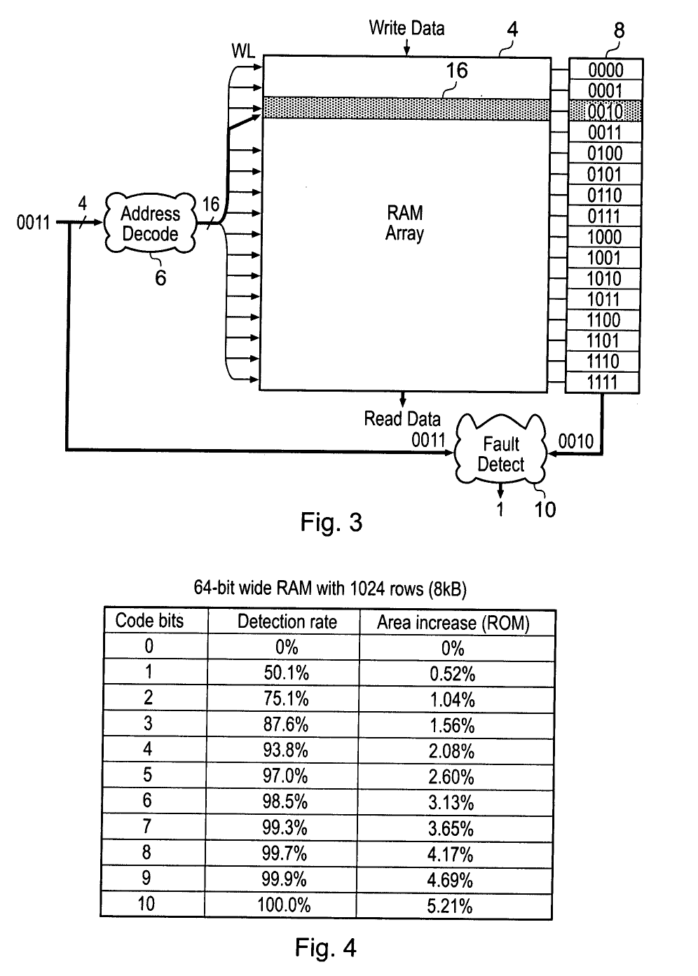

FIG. 3 illustrates the memory of FIG. 1, but in this case there is a fault within the address decoder 6. The same input address signal “0011” that was input in the FIG. 2 example is supplied as an input to the address decoder 6 in FIG. 3. However, in this example, an error within the address decoder 6 (whether a soft error or a hard error) results in an incorrect word line signal WL being generated which erroneously accesses the third row of memory cells 16 within the array 4. The word line signal WL is also passed to the ROM array 8 where the address identifying data for the third row 16 is stored as “0010”. When the address identifying data read “0010” is compared with the input address “0011” by the fault detecting circuitry 10, a mismatch is detected and a signal generated indicating an error within the operation of the address decoder 6.

Various error recovery operations may be performed when an error in the address decoder 6 is detected. It may be that the memory access is simply aborted and then tried again. This would likely deal with a soft error due to a particle strike, since the affect of such a particle strike in producing erroneous operation of the address decoder would likely be temporary and would not affect a subsequent memory access. A hard (permanent or semi-permanent) error would likely persist and accordingly when the memory access was retried, if it failed again, then a more severe recovery strategy could be attempted, such as a system reset or disabling the system with an indication of a fault being passed elsewhere.

It will be appreciated that the number of bits within the address identifying data can vary. The greater the number of bits provided within the address identifying data for each row of memory cells, then the more likely it is that an individual row can be uniquely identified. As an example, if a single bit was dedicated to the address identifying data, then this could only be used to differentiate between odd numbered and even numbered rows within the array 4. An error in the address decoder 6 would likely result in a mismatch in whether the word line signal WL generated properly accessed an odd or even row only approximately half of the time and accordingly the error detection rate would likely only be approximately 50%.

In the example memory being considered in the table of FIG. 4, the memory rows are each 64-bits in length and there are 1024 rows in the array 4. This corresponds to an 8 kB memory. With 1024 rows in the array 4, a 10-bit number is needed to uniquely identify each row. Thus, as the number of bits available for use as the address identifying data increases towards ten, then the error detection rate for errors in the operation of the address decoder 6 rises until, when a full 10-bit address identifying data label is provided then the individual rows can be uniquely identified and the incorrect access of a row substantially always identified. However, with an increase in the number of bits of address identifying data for each row, there is an increase in the overhead associated with providing this extra storage capacity. This is indicated in FIG. 4. If a ROM array 8 is used to store the address identifying the data, then this is formed of ROM memory cells which can be smaller than RAM memory cells reducing the area overhead associated with storing the address identifying data. Since the address identifying data is not dynamic data, and is fixed for the particular form of the memory concerned, the address identifying data can be stored in a ROM array 8 as it does not need to change. However, it may be that in some circumstances it is difficult to provide an ROM array 8 in combination with a RAM array 4 and accordingly the address identifying data could be stored within RAM memory cells (programmable memory cells). Such programmable memory cells have a larger area and accordingly will incur more overhead. However, compared to the previously proposed approach of storing error correction codes and data values separately with separate address decoders, there is still an advantage of a more reliable error detection for a given level of overhead.

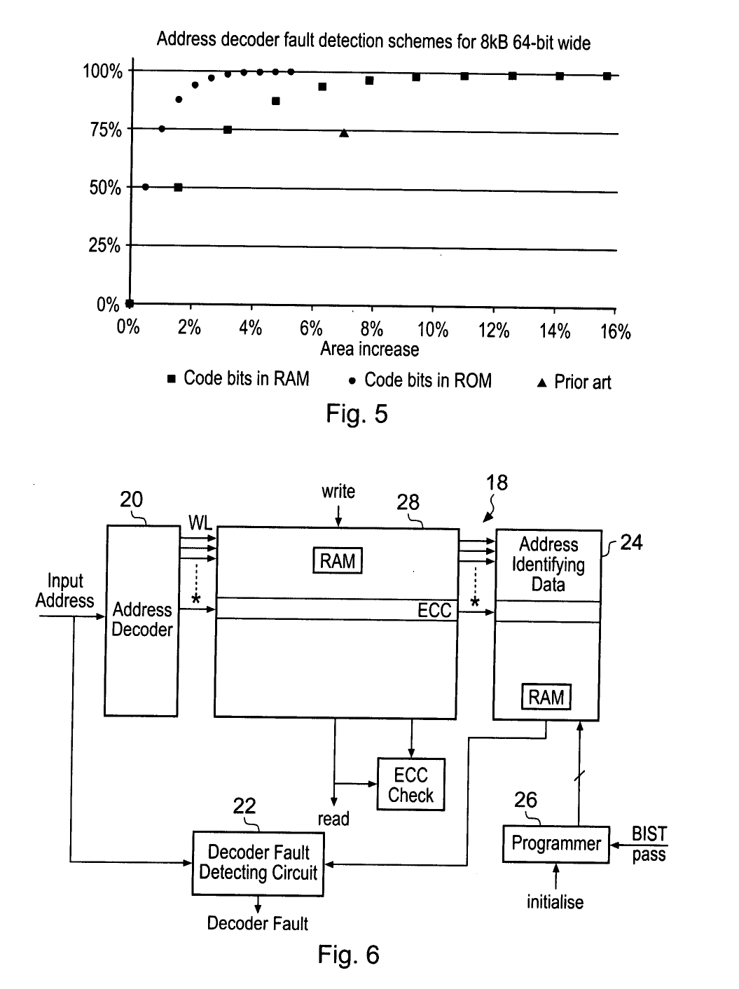

FIG. 5 is a chart illustrating the variation in the degree of error detection coverage achieved compared to the increase in area overhead when different schemes are applied to an 8 kB memory as discussed in relation to FIG. 4. The performance of the previously proposed approach of providing separate address decoders for the data values and the error correcting codes is indicated by the point shown with a triangle in FIG. 5. The variation in fault detection coverage with area increase when using pre-programmed memory cells for the address identifying data (a ROM) is indicated by the points marked with a circle in FIG. 5. It will be seen that the performance achieved converges to substantially 100% when a full 10-bit address identifying value is provided for each row of memory cells within the 1024 row array 4. The variation in detection coverage and area increase when RAM cells are used for the address identifying data is shown by the points marked with squares within FIG. 5. Whilst the trade off in this case is not as good as with ROM cells, the performance is still better than is provided by the duplicate address decoder technique previously proposed.

FIG. 6 illustrates a second example embodiment of a memory 18. In this example the input address is supplied to an address decoder 20 and also to decoder fault detecting circuitry 22. The address identifying data is stored within a RAM array 24 formed of programmable memory cells. The address identifying data is programmed into this RAM array 24 by a programmer circuit 26 upon initialisation of the memory/system. The programmer circuit 26 directly programs the RAM 24 without using the address decoder 20 and writes the sequence of address identifying data entries for each of the memory rows. As an alternative, the programmer circuit 26 can be responsive to a signal indicating that the memory 18 has passed a built-in-self-test (BIST) upon initialisation indicating that the address decoder 20 is operating correctly and in this circumstance the programmer circuit 26 can use the address decoder 20 to access the appropriate row within the RAM array 24 and write the matching address identifying data therein.

Also illustrated in FIG. 6 is the presense of error correcting code data (ECC) within each row of memory cells of the data array 28. This ECC data is used to provide fault detection and fault correction for the data values stored within the row of memory cells concerned. It will be appreciated that the ECC code provides fault detection and error correction in respect of the data values and the address identifying data provides fault detection in respect of the correct memory row being accessed in response to a given input address. These techniques are complementary and synergistic.

As before, the input address is compared with the address identifying data within a decoder fault detecting circuit 22. In this example, the address identifying data may be hash data representing the result of a hashing operation performed upon the input address which properly corresponds to that row of memory cells. Such hash data may be more compact than the full address, or relevant portion of the full address. If such a hashing operation is involved, then the input address supplied to the decoder fault detecting circuit 22 will also be subject to the same hashing operation before the result of that hashing operation is compared with the address identifying data (hash data) retrieved for the memory row being accessed from the RAM array 24. A mismatch is indicative of a decoder fault. It will be appreciated that the hashing operation performed can take a wide variety of different forms.

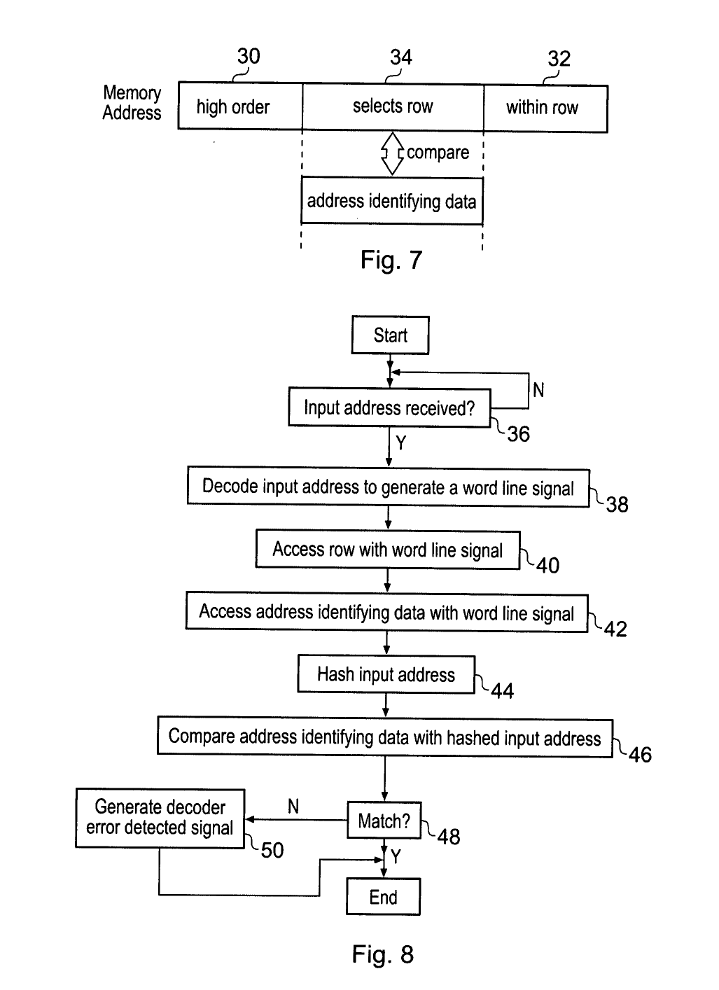

FIG. 7 illustrates a memory address used for accessing a memory 2. As will be appreciated by those in this technical field, such a memory address will include high order bits 30 which serve to effectively select the memory 2 from within other memories which may be provided within the overall memory address space of the system concerned. A low order address portion 32 corresponds to the different bytes of data stored within a given row of memory cells. In the case of a 64-bit memory row, this stores 8 bytes of data and accordingly the low order portion 32 of the memory address will be 3-bits in length. The middle-order portion 34 of the memory address is the portion which selects which row of memory cells 14, 16 is to be accessed within the memory 2. It is the address bits within this middle-order portion 34 which vary with the different rows of the memory array and accordingly can be used to compare against the address identifying data. It may be that only a portion of the bits of this middle-order (row selecting) portion 34 are compared, but greater detection coverage is achieved when all of this middle-order portion 34 is compared with the address identifying data.

FIG. 8 is a flow diagram schematically illustrating the operation of the memory of FIG. 6. At step 36, the memory waits for an input address to be received. At step 38, the input address is decoded to generate a word line signal WL. At step 40, a row of memory cells within the array 28 is accessed using that word line signal WL. At step 42, a word of address identifying data within the array 24 is read with the same word line signal WL generated at step 38. At step 44, the input address is subject to a hashing operation within the decoder fault detecting circuit 22 to produce a hash result. At step 46, the hash result produced from the input address at step 44 is compared with the address identifying data read from the RAM array 24 at step 42. At step 48, a determination is made as to whether or not there was a match at step 46. If there was not a match, then step 50 generates a decoder error detected signal. If there was a match, then step 50 is bypassed and the process terminates.

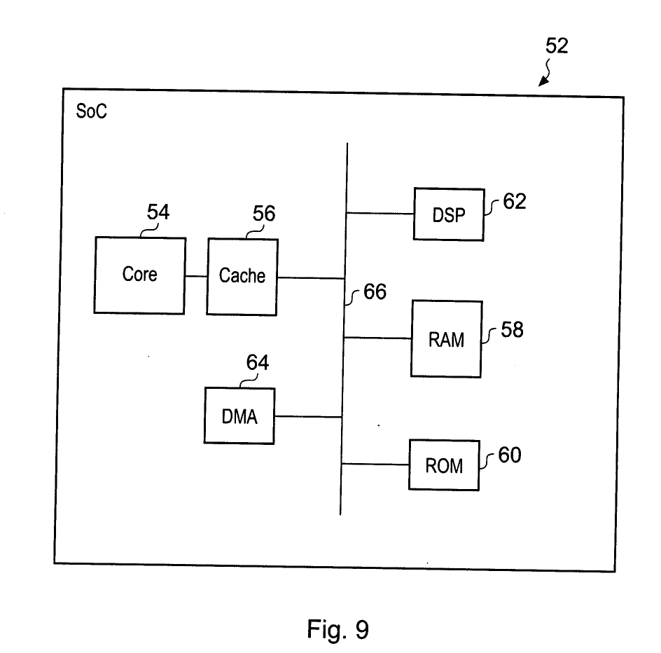

FIG. 9 schematically illustrates a system-on-chip (SoC) integrated circuit 52 of the type with which the present invention may be used. It will be seen that the SoC integrated circuit 52 contains many different elements and multiple memories. In this example the SoC integrated circuit 52 includes a processor core 54, a cache memory 56, a random access memory 58, a read only memory 60, a digital signal processor 62 and a direct memory access unit 64. These elements are connected together by a bus/interconnect 66. The various memories 56, 58, 60 within this SoC integrated circuit 52 can be individually provided with the mechanisms for identifying address decoder faults as previously discussed. It may be that certain of these memories are more prone to hard/soft errors and accordingly the use of the present technique may be more appropriate for some of these elements than for others. As an example, the cache memory 56 will typically be formed of large fast gates which are less likely to be subject to soft errors compared with small high density gates which form the random access memory 58. In this circumstance, it may be desirable to provide the fault detection mechanisms for the address decoders within the random access memory 58, but not within the cache memory 56. However, in highly safety critical systems, the address decoder fault detection technique described above can be provided for all of the memories 56, 58, 60 found on the SoC integrated circuit 52.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A memory comprising:
an array of memory cells;
an address decoder responsive to an input address to generate a word line signal to enable access to a row of memory cells within said array, said word line signal also enabling a read of address identifying data associated with said row and indicative of an address of said row; and
a decoder fault detecting circuit responsive to said input address and said address identifying data to detect incorrect address decoder operation if said address identifying data of said row accessed with said word line signal does not match said input address.

2. A memory as claimed in claim 1, wherein each row of memory cells within said array has different address identifying data associated therewith.

3. A memory as claimed in claim 1, wherein said address identifying data comprises one or more of those bits of said input address which vary when addressing different rows of memory cells within said array.

4. A memory as claimed in claim 3, wherein said address identifying data comprises all of those bits of said input address which vary when addressing different rows of memory cells within said array.

5. A memory as claimed in claim 1, wherein:
said address identifying data is given by a hash function operation performed on said address of said row; and
said decoder fault detecting circuit performs said hash function operation upon said input address to generate an input address hash result and compares said input address hash result with said address identifying data to detect if said address identifying data matches said input address.

6. A memory as claimed in claim 1, wherein said address identifying data is stored within one or more programmable memory cells associated with said array and having read access triggered with said word line signal for said row, write access to said one or more programmable memory cells being disabled after said address identifying data is stored therein.

7. A memory as claimed in claim 6, wherein said one or more further programmable memory cells are programmed with said address identifying data using a programming circuit and independently of said address decoder.

8. A memory as claimed in claim 6, wherein said one or more further programmable memory cells are programmed with said address identifying data at memory initialisation and associated with a memory test sensitive to correct operation of said address decoder.

9. A memory as claimed in claim 1, wherein said address identifying data is stored within one or more preprogrammed read only memory cells associated with said array and having read access triggered with said word line signal for said row.

10. A memory as claimed in claim 1, wherein said row of memory cells has error correcting code data associated therewith, an error correcting code circuit being responsive to said error correcting code data for a row to detect and correct at least some errors within data values stored within said row.

11. A memory as claimed in claim 1, wherein said memory is at least part of a cache memory.

12. A memory as claimed in claim 1, wherein said memory is at least part of a random access memory.

13. A memory as claimed in claim 1, wherein said memory is a compiled memory and said address identifying data is stored within extra memory cells within said row.

14. A memory as claimed in claim 1, wherein said memory is part of a system-on-chip integrated circuit.

15. A memory comprising:
an array of memory cells;
address decoder means for generating a word line signal in response to an input address to enable access to a row of memory cells within said array, said word line signal also enabling a read of address identifying data associated with said row and indicative of an address of said row; and
decoder fault detecting means for detecting incorrect address decoder operation in response to said input address and said address identifying data if said address identifying data of said row accessed with said word line signal does not match said input address.

16. A method of operating a memory having an array of memory cells, said method comprising the steps of:
decoding an input address to generate a word line signal to enable access to a row of memory cells within said array, said word line signal also enabling a read of address identifying data associated with said row and indicative of an address of said row; and
detecting incorrect decoding if said address identifying data of said row accessed with said word line signal does not match said input address.

17. A method as claimed in claim 16, wherein each row of memory cells within said array has different address identifying data associated therewith.

18. A method as claimed in claim 16, wherein said address identifying data comprises one or more of those bits of said input address which vary when addressing different rows of memory cells within said array.

19. A method as claimed in claim 18, wherein said address identifying data comprises all of those bits of said input address which vary when addressing different rows of memory cells within said array.

20. A method as claimed in claim 16, wherein:
said address identifying data is given by a hash function operation performed on said address of said row; and
said detecting comprises performing said hash function operation upon said input address to generate an input address hash result and comparing said input address hash result with said address identifying data to detect if said address identifying data matches said input address.

21. A method as claimed in claim 16, wherein said address identifying data is stored within one or more programmable memory cells associated with said array and having read access triggered with said word line signal for said row, write access to said one or more programmable memory cells being disabled after said address identifying data is stored therein.

22. A method as claimed in claim 21, wherein said one or more further programmable memory cells are programmed with said address identifying data independently of said address decoder.

23. A method as claimed in claim 21, wherein said one or more further programmable memory cells are programmed with said address identifying data at memory initialisation and associated with memory test sensitive to correct operation of said decoding.

24. A method as claimed in claim 16, wherein said address identifying data is stored within one or more preprogrammed read only memory cells associated with said array and having read access triggered with said word line signal for said row.

25. A method as claimed in claim 16, wherein said row of memory cells has error correcting code data associated therewith and further comprising detecting and correcting at least some errors within data values stored within said row using said error correcting code data.

26. A method as claimed in claim 16, wherein said memory is at least part of a cache memory.

27. A method as claimed in claim 16, wherein said memory is at least part of a random access memory.

28. A method as claimed in claim 16, wherein said memory is a compiled memory and said address identifying data is stored within extra memory cells within said row.

29. A method as claimed in claim 16, wherein said memory is part of a system-on-chip integrated circuit.
